(19) United States
(12) Patent Application Publication
(10) Pub. No.: US 2025/0374190 A1
(43) Pub. Date: Dec. 4, 2025

(54) LOW-POWER SYNC SIGNAL FOR LP-WUR

(71) Applicant: QUALCOMM Incorporated, San Diego, CA (US)

(72) Inventors: Linhai HE, San Diego, CA (US); Yuchul KIM, San Diego, CA (US); Ahmed ELSHAFIE, San Diego, CA (US); Zhikun WU, Beijing (CN); Peter GAAL, San Diego, CA (US); Jing LEI, San Diego, CA (US)

(21) Appl. No.: 18/875,110

(22) PCT Filed: Jul. 15, 2022
(86) PCT No.: PCT/CN2022/105932

§ 371 Date: Dec. 13, 2024

(51) Int. Cl. H04W 52/02; H04L 5/00; H04W 76/27

(52) U.S. Cl. CPC H04W 52/0235; H04L 5/0005; H04W 76/27

(57) ABSTRACT

A method of wireless communication at a UE includes performing one or more RRM measurements on a LP-RS of at least one cell. The method further includes selecting a cell on which to camp based on the one or more RRM measurements performed on the LP-RS.

### TECHNICAL FIELD

The present disclosure relates generally to communication systems, and more particularly, to wireless communication including synchronization.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus is configured to perform one or more radio resource management (RRM) measurements on a low-power reference signal (LP-RS) of at least one cell and select a cell on which to camp based on the one or more RRM measurements performed on the LP-RS.

In an aspect of the disclosure, a method, a computer-readable medium, and an apparatus are provided for wireless communication at a network node. The apparatus is configured to transmit a synchronization signal block (SSB) for a cell and transmit a low-power reference signal (LP-RS) associated with the cell, the LP-RS configured for reception with a lower power than the SSB.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and a UE in an access network.

FIG. 4 is a diagram illustrating an example of a low-power reference signal (LP-RS) according to a first configuration.

FIG. 5 is a diagram illustrating an example of a LP-RS according to a second configuration.

FIG. 6 is a diagram illustrating an example communications flow.

FIG. 7 is a flowchart of a method of wireless communication.

FIG. 8 is a flowchart of another method of wireless communication.

FIG. 9 is a diagram illustrating an example of a hardware implementation for an example apparatus and/or network entity.

FIG. 10 is a diagram illustrating an example of a hardware implementation for an example network entity.

### DETAILED DESCRIPTION

A UE may be equipped with a low-power wakeup radio (LP-WUR) that utilizes less power than a main radio of the UE. In some aspects, a UE may use a LP-WUR to monitor for a LP-WUS. Aspects presented herein enable the UE to utilize a LP-WUR in different contexts (e.g., for synchronization) in order to reduce UE power consumption. To address issues pertaining to UE power consumption, enhancements to UE synchronization procedures using a LP-RS are described herein. In an example, a UE performs one or more RRM measurements (e.g., layer 3 reference signal received power (L3-RSRP) measurements) on a LP-RS of at least one cell and selects a cell on which to camp based on the one or more RRM measurements performed on the LP-RS. Thus, the UE may utilize the LP-RS for cell selection/reselection purposes without having to continually measure SSBs. As measuring the LP-RS may consume less UE power than measuring an SSB, UE power consumption is reduced. According to some configurations, the UE utilizes for LP-RS for additional purposes such as cell barring, intra-frequency reselection, and/or system information change.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (e.g., referred to as gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

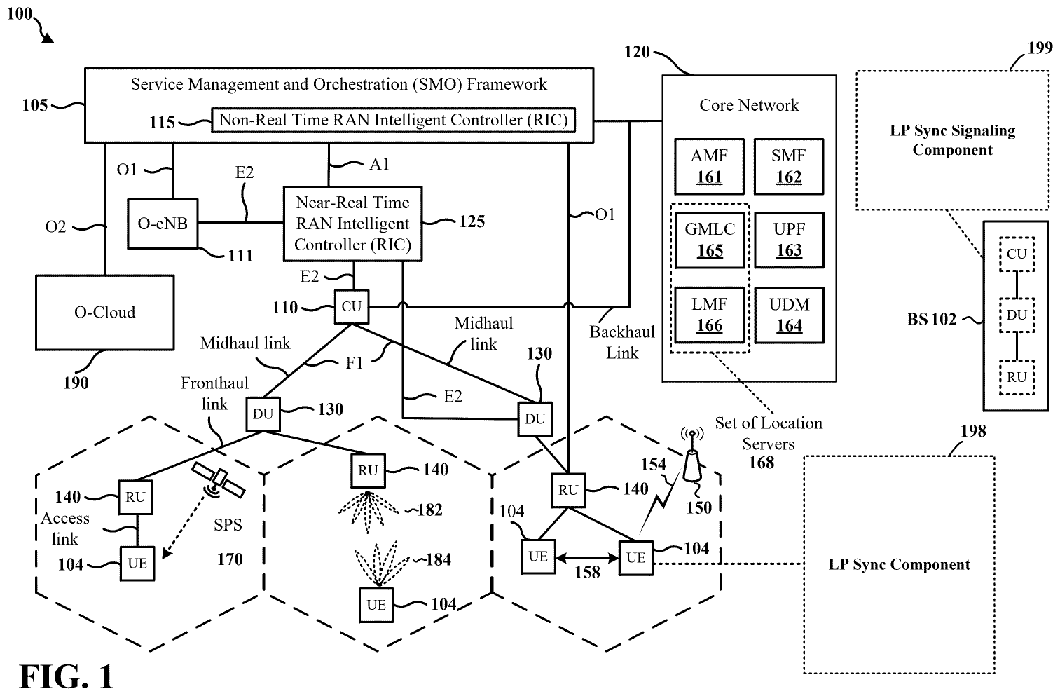

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a LP sync component that is configured to perform one or more RRM measurements on a LP-RS of at least one cell and select a cell on which to camp based on the one or more RRM measurements performed on the LP-RS. In certain aspects, the base station 102 include a LP sync signaling component 199 that is configured to transmit a SSB for a cell and transmit a LP-RS associated with the cell, the LP-RS configured for reception with a lower power than the SSB. Although the following description may be focused on 5G NR, the concepts described herein may be applicable to other similar areas, such as LTE, LTE-A, CDMA, GSM, and other wireless technologies.

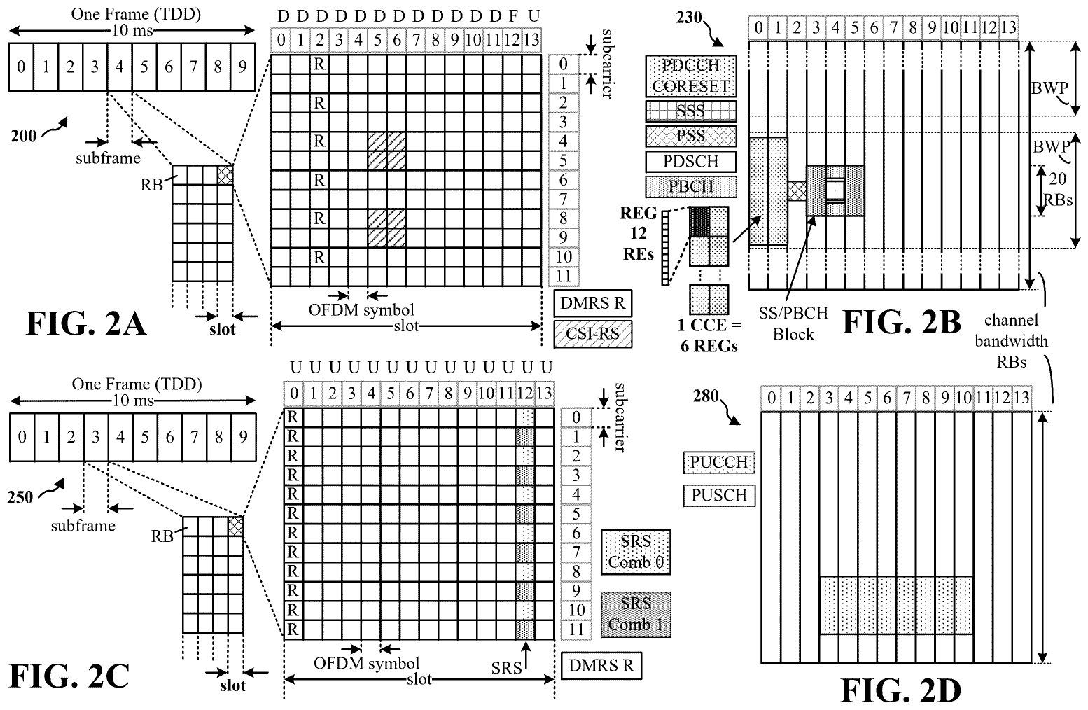

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δƒ = 2^{μ} · 15 [KHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identity (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

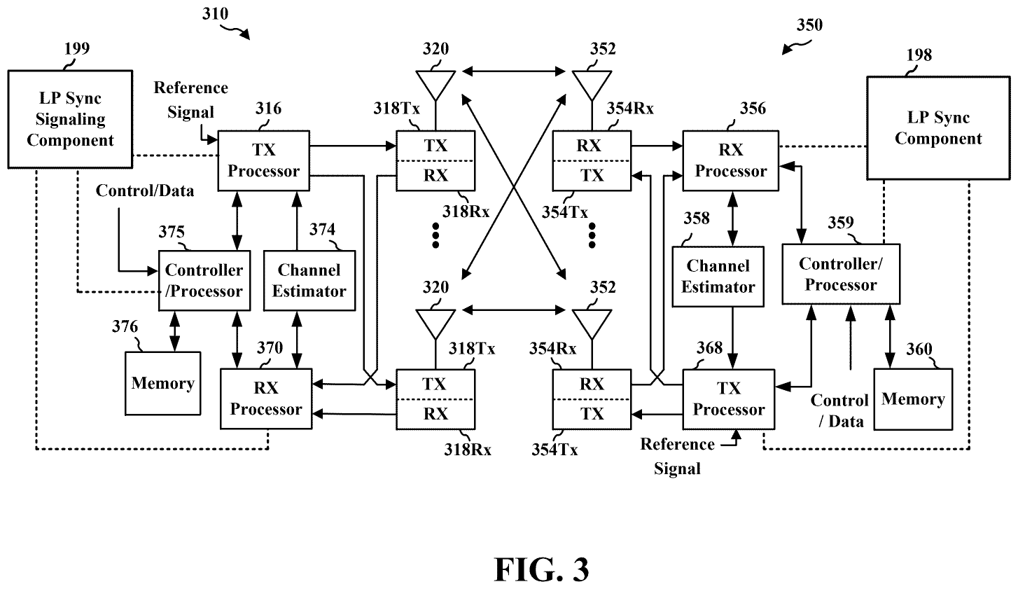

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the LP sync component 198 of FIG. 1.

At least one of the TX processor 316, the RX processor 370, and the controller/processor 375 may be configured to perform aspects in connection with the LP sync signaling component 199 of FIG. 1.

In RRC idle and inactive states, radio resource management (RRM) and paging may consume significant UE power. In an example, in RRM, the UE periodically performs layer 3 reference signal received power (L3-RSRP) measurements on SSBs transmitted by a serving cell of the UE and neighbor cells of the UE. Such L3-RSPRP measurements consume power at the UE. In another example, in paging, the UE may periodically monitors a paging occasion (PO) during each idle discontinuous reception (I-DRX) cycle.

A UE may be configured with resources to monitor for a wakeup signal (WUS). When configured, the UE wakes up a configurable amount of time before a start of a long discontinuous reception (DRX) cycle. The UE then checks for the WUS. If the UE does not receive the WUS, the UE returns to sleep for the next long DRX cycle. WUSs may reduce power consumption for UEs. In some configurations, a WUS may be transmitted over the PDCCH (such a wakeup signal may be referred to as a PDCCH-WUS).

In some configurations, a UE may be equipped with a low-power wakeup radio (LP-WUR) that utilizes less power than a main radio of the UE. In an example, the LP-WUR may utilize less than 1 mA. The LP-WUR may be configured to receive a low-power wakeup signal (LP-WUS). A UE that utilizes the LP-WUS for wakeup purposes may consume less power than a UE that utilizes the PDCCH-WUS for wakeup purposes. The LP-WUR may utilize an on off keying (OOK) modulation scheme. The OOK modulation scheme may limit a payload size of a LP-WUS. There is a need to utilize a LP-WUR in different contexts (e.g., for synchronization) in order to reduce UE power consumption.

Aspects presented herein enable further reductions in UE power consumption by through the use of a LP-RS and a LP-WUR for synchronization or RRM. A base station may transmit a LP-RS, and a UE may use a LP-WUR to receive the LP-RS. In some aspects, a location of the LP-RS may be defined or configured with respect to a synchronization raster or may be provided in signaling such as remaining minimum system information (RMSI).

The UE may perform a measurement (e.g., a L3-RSRP measurement) on the LP-RS. The use of the LP-RS and the LP-WUR to perform the measurements may help the UE to reduce the power to perform such measurements. The UE may also perform measurements on LP-RSs received by the LP-WUR from neighbor cells. In some aspects, the UE may use the RSRP measurement on the LP-RS to derive an equivalent RSRP measurement value for a corresponding measurement on an SSB. The UE may utilize the equivalent RSRP measurements on the SSB in cell selection/reselection. As the LP-WUR receives the LP-RSs (as opposed to a main radio of the UE which receives SSBs), the UE may be able to perform cell selection/reselection using less power than cell selection/reselection performed using SSBs. According to some configurations, the UE may use the LP-RS for additional purposes such as cell barring, intra-frequency reselection, and/or system information changes.

In an example, a UE performs one or more RRM measurements on a LP-RS of at least one cell and selects a cell on which to camp based on the one or more RRM measurements performed on the LP-RS. Thus, the UE may utilize the LP-RS for cell selection/reselection purposes without having to measure SSBs, which may use more power at the UE. As measuring the LP-RS consumes less UE power than measuring an SSB, UE power consumption is reduced.

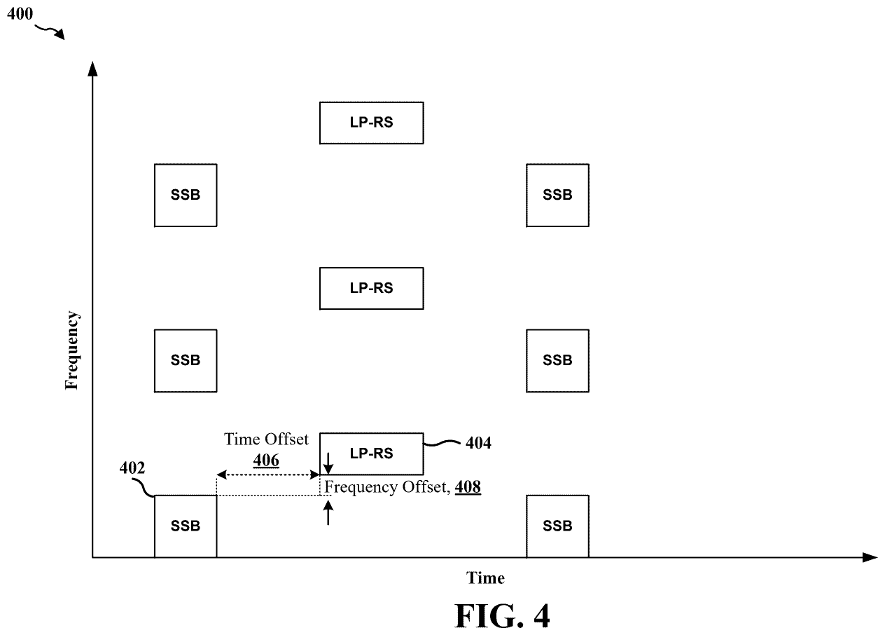

FIG. 4 is a diagram 400 illustrating example aspects of LP-RSs. The diagram 400 includes an SSB 402 and a LP-RS 404. A base station (e.g., the base station 102, the base station 310, the base station 604, the network entity 902, etc.) may transmit the SSB 402 and the LP-RS 404. The UE (e.g., the 102, the UE 350, the UE 602, the apparatus 904, etc.) may use a different receiver or radio (e.g., a LP-WUR) to receive the LP-RS than to receive the SSB. The LP-WUR may use less power at the UE than the other receiver or radio (e.g., which may be referred to as a higher power receiver or radio) that the UE uses to receive the SSB.

The LP-RS may be structured such that a UE uses less power to receive the LP-RS than the SSB. The LP-RS may include a different waveform than the SSB and/or a different modulation than the SSB, the waveform or modulation of the LP-RS being received using less power than the waveform/modulation of the SSB. In some aspects, the waveform and/or modulation of the LP-RS may be the same as a waveform or modulation for a LP-WUS. As illustrated in FIG. 4, the LP-RS 404 may span less frequency resources than the SSB 402. For example, the base station may transmit the LP-RS 404 in a narrower frequency band over a longer period of time than the SSB 402. In some aspects, the LP-RS 404 may include a defined sequence transmitted by a serving cell. The defined sequence of the LP-RS 404 may be scrambled by a PCI, or a payload of the LP-RS may carry the PCI for cell identification.

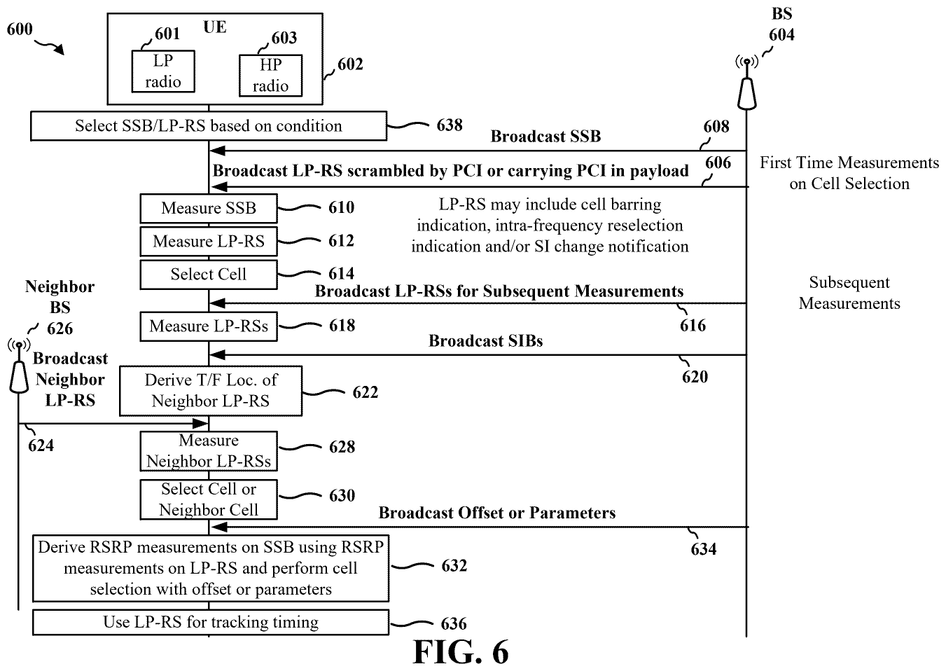

FIG. 6 includes a diagram 600 that includes an example at 606 of a base station 604 broadcasting an LP-RS. The UE may include multiple receivers or multiple radios. FIG. 6 illustrates the UE having a low power radio 601 (which may be referred to as a low power receiver, a low power transceiver, or a LP-WUR) and an additional radio 603 (which may be referred to as a higher power radio, a higher power receiver, a higher power transceiver, etc.) and which may use more power at the UE than the radio 601. A UE 602, such as a UE in an RRC idle or inactive state may receive the LP-RS using a LP-WUR. A base station (e.g., the base station 102, the base station 310, the base station 604, the network entity 902, etc.) may transmit the LP-RS 404 (e.g., the 102, the UE 350, the UE 602, the apparatus 904, etc.) using the same waveform and modulation as a LP-WUS. In an example, the base station may transmit the LP-RS 404 using an OOK modulation scheme. In another example, the base station may transmit the LP-RS 404 using an OFDMA modulation scheme. A LP-WUR, e.g., 601, of the UE can receive the LP-RS. The LP-WUR utilizes less power than a main radio, e.g., 603, of the UE 602. As a result, measurements performed on the LP-WUS (e.g., L3-RSRP measurements) by the UE consume less UE power in comparison to measurements performed on the SSB (which is received by the main radio) by the UE.

The diagram 400 in FIG. 4 shows a location of the LP-RS 404 being defined based on a time offset 406 and a frequency offset 408 with respect to a synchronization raster (also referred to as a sync raster). The synchronization raster defines known locations of transmission locations of SSBs. Through use of the synchronization raster, the UE knows locations of the SSBs. As the UE knows a time and frequency location of the SSB 402 through the synchronization raster, the UE may determine, or know, a time and frequency location of the LP-RS 404. The base station may transmit LP-RSs with a periodicity that is longer than a periodicity of SSBs due to RRM measurements being performed in idle mode DRX or extended DRX. For instance, the UE may not need to measure LP-RSs at the same rate as SSBs, which are typically transmitted every 20 ms. Through use of repetitions, the LP-RS 404 may have similar or the same coverage as the SSB 402. The base station may configure a number of repetitions of LP-RSs.

In one aspect, the UE may determine a time and frequency location of the SSB 402 based on the sync raster. The UE may determine a location of the LP-RS 404 based on the time and frequency location of the SSB 402.

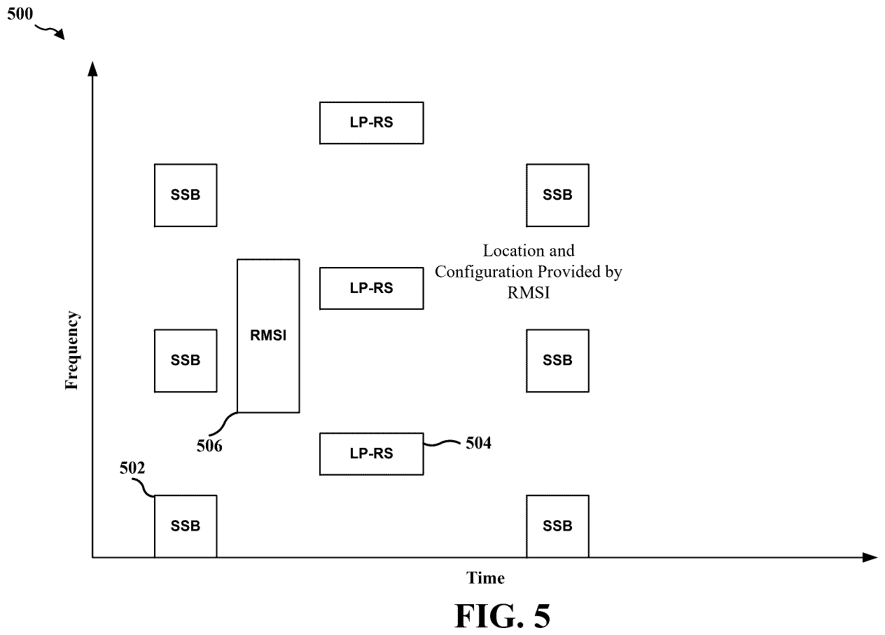

FIG. 5 is a diagram 500 illustrating aspects of LP-RSs. The diagram 500 includes an SSB 502 and a LP-RS 504. The modulation and/or waveform of the LP-RS may include aspects as described in connection with FIG. 4. In an example, the base station may transmit the LP-RS 504 using OOK modulation. In another example, the base station may transmit the LP-RS 504 using OFDMA modulation. The SSB 502 and the LP-RS 504 may be similar to the SSB 402 and the LP-RS 404. However, unlike the LP-RS 404, a location and other configuration information of the LP-RS 504 may be transmitted by the base station. For example, the location of the LP-RS and/or other configuration for the LP-RS may be included in RMSI 506. The RMSI 506 may be referred to as SIB1. The SSB 502 may carry information that the UE uses to receive the RMSI. The RMSI 506 includes system information that the UE utilizes to access a RAN, such as information needed by the UE to carry out initial random access. The base station periodically broadcasts the RMSI 506 over a cell area. For example, referring to FIG. 6, at 620, the base station 604 broadcasts SIBs (which may include the RMSI 506) to the UE 602 and the UE 602 receives the SIBs.

In some aspects, the UE may utilize the LP-RS 404 or the LP-RS 504 in cell selection and/or reselection. Utilizing the LP-RS 404 or the LP-RS 504 instead of the SSB 402 or the SSB 502 for cell selection and/or reselection may reduce an amount of time that the UE wakes up the main radio (unless the UE receives a page or a short message). By reducing the use of the main radio, the use of the LP-RS for cell selection/reselection may result in reduced power consumption by the UE.

In one aspect, the UE utilizes the LP-RS 404 or the LP-RS 504 for serving cell measurements. For example, in FIG. 6 at 608, the base station 604 broadcasts an SSB to the UE 602 when the UE 602 selects a cell associated with the base station 604 for the first time. The UE 602 receives the SSB at the main radio. Subsequently, at 606, the base station 604 broadcasts the LP-RS to the UE 602. The UE 602 receives the LP-RS at a LP-WUR. At 610, the UE 602 measures the SSB (e.g., using L3-RSRP). In an example, the UE 602 may measure the SSB using a high power (HP) radio 603. At 612, the UE 602 measures the LP-RS (e.g., using L3-RSRP). In an example, the UE 602 may measure the LP-RS using a low-power (LP) radio 601. At 614, the UE 602 selects the cell to camp on based upon the measurements performed on the SSB and/or the LP-RS. At 616, for subsequent serving cell measurements occurring after the first cell measurement, the base station 604 broadcasts LP-RSs for subsequent measurements by the UE 602. The UE 602 receives the LP-RSs at the LP-WUR. At 618, the UE 602 measures the LP-RSs instead of SSBs.

In one aspect, the UE utilizes LP-RSs for neighbor cell measurements. For example, in FIG. 6 at 620, the base station 604 transmits SIBs (e.g., SIB3/4/5) to the UE 602. The SIBs may include system information of a set of neighbor cells that are to be measured. The UE 602 receives the SIBs (e.g., at the main radio). At 622, the UE 602 derives the time and frequency location of a neighbor LP-RS broadcast by a neighbor BS 622 (i.e., a neighbor cell) using relationships between SSBs and LP-RSs described above in FIGS. 4 and 5 (e.g., using the sync raster). At 624, a neighbor base station 626 broadcasts the neighbor LP-RS to the UE 602. The UE 602 receives the neighbor LP-RS at the LP-WUR. At 628, the UE 602 measures the neighbor cell associated with the neighbor base station 626 using the neighbor LP-RS (e.g., using L3-RSRP measurements) without having to measure its respective SSB. At 630, the UE 602 selects the neighbor cell or the cell associated with the base station 604 to camp on based upon their respective measurements.

In one aspect, the UE utilizes L3-RSRP measurements on the LP-RSs to derive equivalent L3-RSRP measurements on SSBs. The UE may then compare the derived equivalent measurement to a threshold/cell selection or reselection parameter for the SSB and/or to other measurements of SSBs. For example, in FIG. 6 at 632, the UE 602 may derive an L3-RSRP measurement on an SSB using a L3-RSRP measurement on the LP-RS by applying on offset to the L3-RSRP measurement on the LP-RS. The UE 602 may derive the offset from its own measurements (e.g., measurements on an initial SSB) or the UE 602 may be provided with the offset by a network. The UE 602 may periodically measure an SSB to determine whether a derived offset is still valid and/or whether an adjustment to the derived offset is required. For instance, at 634, the base station 604 may broadcast the offset to the UE 602. The UE 602 receives the offset and applies the offset at 632. Thus, the UE 602 may use the equivalent L3-RSRP measurements on the SSB and legacy cell selection/reselection criteria to perform cell selection/reselection. Thus, after deriving the equivalent L3-RSRP measurements on the SSB, the UE 602 may utilize existing cell selection/reselection procedures without having to utilize new LP-RS cell selection criteria. In another aspect, the UE 602 utilizes reference signal received quality (RSRQ) measurements on the LP-RS to derive equivalent RSRQ measurements on the SSB.

In some aspects, a network may configure a separate set of measurements and cell selection/reselection parameters for LP-RS. The UE may then compare the LP-RS measurements to the corresponding thresholds/cell (re)selection parameters rather than deriving a corresponding SSB measurement. For example, in FIG. 6 at 634, the base station 604 may broadcast the parameters to the UE 602. The UE 602 may receive the parameters. The parameters may include selection criteria (Scriteria) such as Qrxlevmin/Qqualmin, Qrxlevminoffset/Qqualminoffset, Pcompensation, and/or Qoffsettemp. The parameters may also include thresholds for performing neighbor cell RRM measurements, such as SIntraSearchP, SIntraSearchQ, SnonlntraSearchP, and/or SnonlntraSearchQ. At 632, the UE 602 may utilize the parameters to perform cell selection/reselection.

In one aspect, the LP-RS 404 or the LP-RS 504 may include a cell barring indication, an intra-frequency reselection indication, and/or a system information (SI) change notification. For example, in FIG. 6 at 606 and 616, the base station 604 may transmit LP-RSs that include cell barring indications, intra-frequency reselection indications, and/or SI change notifications. Cell barring indications are used by a network to inform a UE as to whether new UEs are being accepted. Intra-frequency reselection indications inform a UE that if cell barring is occurring on a frequency, all cells on the same frequency are also barred. The SI change notifications inform the UE of system information changes. The cell barring indications, the intra-frequency reselection indications, and/or the SI change notifications in the LP-RS 404 or the LP-RS 504 may enable the UE 602 to obtain barring status of neighbor cells without having to wake the main radio to check MIBs/SIB1 of neighbor cells periodically.

In one aspect, the LP-RS 404 or the LP-RS 504 may be used as a reference signal for tracking timing of a serving cell of a UE. For example, in FIG. 6 at 636, the UE 602 uses an LP-RS for tracking timing of a serving cell.

In one aspect, the UE selects the SSB or the LP-RS to measure based on one or more conditions. For example, referring to FIG. 6 at 638, the UE 602 selects the SSB or the LP-RS based on a condition. The one or more conditions may include a RSRP of a downlink reference signal of the UE meeting a threshold, a location of the UE within a cell, and/or a mobility condition of the UE.

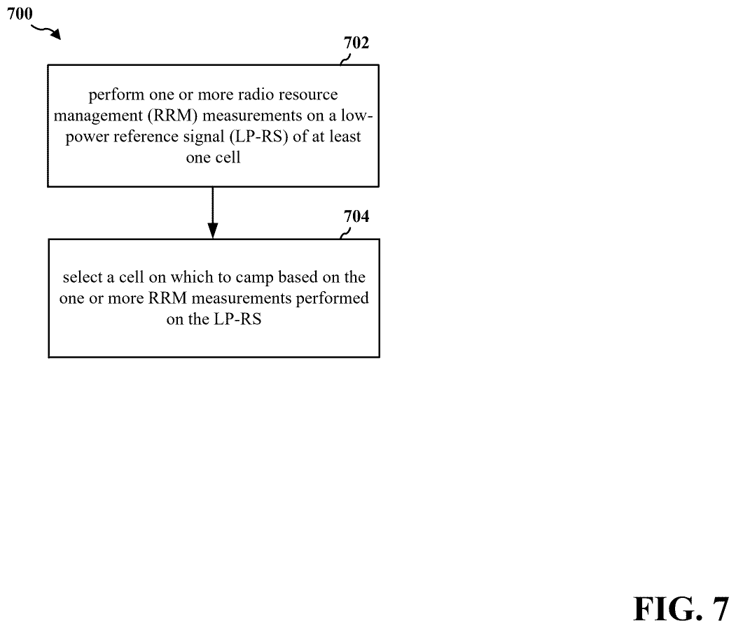

FIG. 7 is a flowchart 700 of a method of wireless communication. The method may be performed by a UE (e.g., the UE 104, the UE 350, the UE 602, the apparatus 904). In an example, the method (including the various configurations described below) may be performed by the LP sync component 198. The method may be associated with various advantages for the UE, such as reduced UE power consumption.

At 702, the UE performs one or more RRM measurements on a LP-RS of at least one cell. For example, referring to FIG. 6, at 612, the UE 602 measures an LP-RS broadcast by the base station 604. In another example, referring to FIG. 4, an LP-RS 404 is depicted. In yet another example, referring to FIG. 5, a LP-RS 504 is depicted.

At 704, the UE selects a cell on which to camp based on the one or more RRM measurements performed on the LP-RS. For example, referring to FIG. 6, at 614, the UE 602 selects a cell on which to camp based upon measurements on the LP-RS performed at 612.

In one configuration, the LP-RS may be configured for reception with a reduced power relative to reception of a SSB for the at least one cell. For example, referring to FIG. 6, at 608 and 606, the UE 602 may receive an SSB and a LP-RS, at the LP-RS may be configured for reception with reduced power compared to the SSB.

In one configuration, the UE may include a first receiver and a second receiver that operates using less power than the first receiver, and wherein the one or more RRM measurements are performed on the LP-RS using the second receiver of the UE. For example, referring to FIG. 1, the LP sync component 198 may include a first receiver and a second receiver that operates using less power than the first receiver and the UE may perform RRM measurements on the LP-RS using the second receiver. In another example, referring to FIG. 6, the LP sync component 198 may perform RRM measurements via the LP radio 601.

In one configuration, prior to receiving the LP-RS associated with a serving cell, the UE may receive a SSB associated with the serving cell. For example, referring to FIG. 6, at 608, the UE 602 may receive the broadcast SSB associated with the base station 604. In such a configuration, the UE may acquire information about the LP-RS based on the SSB or from RMSI associated with the SSB. For example, referring to FIG. 4, the UE may acquire information about the LP-RS 404 based upon the SSB 402. In another example, referring to FIG. 5, the UE may acquire information about the LP-RS 504 based upon the RMSI 506.

In one configuration, prior to receiving the LP-RS associated with a serving cell, the UE may determine a time and frequency location of a SSB associated with the serving cell based on a sync raster. For example, referring to FIG. 4, the UE may determination a time and frequency location of the SSB 402 using a sync raster. In such a configuration, the UE may determine a location of the LP-RS based on the time and frequency location of the SSB associated with the serving cell. For example, referring to FIG. 4, the UE may determine a location of the LP-RS 404 based upon the SSB 402.

In one configuration, the LP-RS may be transmitted at a first periodicity and the SSB is transmitted at a second periodicity. For example, referring to FIG. 4, the LP-RS 404 is transmitted at a first periodicity and the SSB 402 is transmitted at a second periodicity. In another example, referring to FIG. 5, the LP-RS 504 is transmitted at a first periodicity and the SSB 502 is transmitted at a second periodicity.

In one configuration, wherein the UE may be in a RRC idle or inactive state. For example, referring to FIG. 6, at 612 and 614, the UE 602 may be in a RRC idle or inactive state when the UE 602 measures LP-RS and selects the cell based upon the measured LP-RS.

In one configuration, the LP-RS may be identified by a PCI for a serving cell. For example, referring to FIG. 6, at 606, the broadcast LP-RS may be identified by a PCI associated with the base station 604.

In one configuration, the LP-RS may include a payload that carries the PCI. For example, referring to FIG. 6, at 606, the broadcast LP-RS may carry a PCI in a payload.

In one configuration, the LP-RS may include a payload that includes at least one of: a cell barring indication, an intra-frequency reselection indication, or a system information change notification. For example, referring to FIG. 6, at 606, the LP-RS may include a cell barring indication, an intra-frequency reselection indication, and/or a SI change notification.

In one configuration, the LP-RS may comprise an OOK modulation scheme or an OFDMA modulation scheme. For example, referring to FIG. 4, the LP-RS 404 may comprise an OOK modulation scheme or an OFDMA modulation scheme. In another example, referring to FIG. 5, the LP-RS 504 may comprise an OOK modulation scheme or an OFDMA modulation scheme.

In one configuration, the one or more RRM measurements may comprise L3-RSRP measurements. For example, referring to FIG. 6, at 612, the UE 602 may perform L3-RSRP measurements on the LP-RS. For example, the UE 602 may perform a measurement on the LP-RS using the LP radio 601.

In one configuration, the UE may perform, prior to receiving the LP-RS associated with a serving cell, a first measurement on a SSB associated with the serving cell. For example, referring to FIG. 6, at 610, the UE 602 may perform a measurement on the SSB associated with the base station 604. For example, the UE 602 may perform a measurement on the SSB using the HP radio 603.

In one configuration, the UE may perform cell reselection based on the one or more RRM measurements performed on the LP-RS for the cell and second one or more RRM measurements performed on a second LP-RS for at least one neighbor cell. For example, referring to FIG. 6, at 612 and 628 the UE 602 may perform measurements on the LP-RS transmitted by the base station 604 and an LP-RS transmitted by the neighbor base station 626 and at 630 the UE 602 may perform cell reselection based upon the respective measurements.

In one configuration, the UE may derive time and frequency locations of LP-RSs associated with at least one neighbor cell indicated in system information. For example, referring to FIG. 6, at 620 the UE 602 may receive broadcast SIBs and at 622 the UE may derive time and frequency locations of an LP-RS broadcast by the neighbor base station 626. In such a configuration, performing the one or more RRM measurements for the at least one cell includes performing second one or more RRM measurements on the LP-RSs of the at least one neighbor cell. For example, referring to FIG. 6, at 628, the UE 602 may measure the LP-RS associated with the neighbor base station 626.

In one configuration, the UE may derive an estimated RSRP of a corresponding SSB based upon the one or more RRM measurements on the LP-RS and an offset. For example, referring to FIG. 6, at 632, the UE 602 may derive RSRP measurements on an SSB based upon measurements on the LP-RS performed at 612 and an offset. In such a configuration, the UE may select the cell based on the estimated RSRP of the corresponding SSB and a threshold. For example, referring to FIG. 6, at 632, the UE 602 may perform cell selection or reselection based upon derived RSRP measurements on the SSB.

In one configuration, the UE may estimate the offset based upon a difference between the one or more RRM measurements performed on the LP-RS and corresponding RRM measurements performed on the corresponding SSB. For example, referring to FIG. 6, at 632, the UE may estimate the offset.

In one configuration, the UE may receive the offset from a network node. For example, referring to FIG. 6, at 634, the UE 602 may receive the offset from the base station 604.

In one configuration, the UE may receive an LP-RS cell selection parameter from a network entity, the LP-RS cell selection parameter being different than an SSB cell selection parameter, where selecting the cell is further based upon the LP-RS cell selection parameter. For example, referring to FIG. 6, at 634, the UE 602 may receive cell selection parameters from the base station 604.

In one configuration, the UE may select, prior to performing the one or more measurements on the LP-RS of the at least one cell, the LP-RS based on at least one condition. For example, referring to FIG. 6, at 638, the UE may select the SSB based on a condition.

In one configuration, the LP-RS may be selected from a group comprising the LP-RS and a SSB. For example, referring to FIG. 6, at 638, the LP-RS may be selected from a group that includes the SSB and the LP-RS.

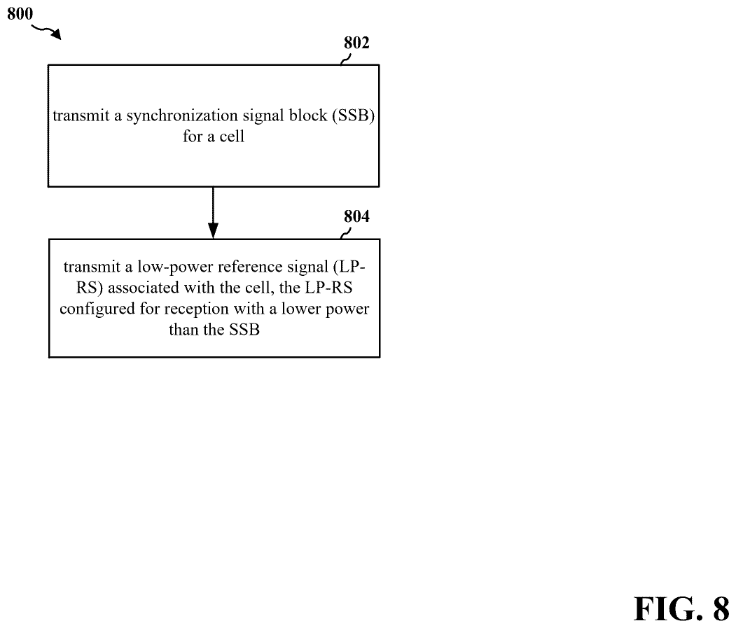

FIG. 8 is a flowchart 800 of a method of wireless communication. The method may be performed by a network node (e.g., the base station 102, the base station 310, the base station 604, the network entity 902). In an example, the method (including the various configurations described below) may be performed by the LP sync signaling component 199. At 802, the network node transmits a SSB for a cell. For example, referring to FIG. 6, at 608, the base station 604 broadcasts the SSB. In another example, referring to FIG. 4, a base station transmits the SSB 402. In yet another example, referring to FIG. 5, a base station transmits the SSB 502.

At 804, the network node transmits a LP-RS associated with the cell, the LP-RS configured for reception with a lower power than the SSB. For example, referring to FIG. 6, at 606, the base station 604 broadcasts the LP-RS. In another example, referring to FIG. 4, a base station transmits the LP-RS 404. In yet another example, referring to FIG. 5, a base station transmits the LP-RS 504.

In one configuration, the LP-RS may be broadcast at a first periodicity and the SSB is broadcast at a second periodicity. For example, referring to FIG. 4, a base station broadcasts the LP-RS 404 at a first periodicity and the SSB 402 at a second periodicity. In another example, referring to FIG. 5, a base station broadcasts the LP-RS 504 at a first periodicity and the SSB 502 at a second periodicity.

In one configuration, the LP-RS may be identified by a PCI for the cell. For example, referring to FIG. 6, at 606, the broadcast LP-RS may be identified by a PCI associated with the base station 604.

In one configuration, the LP-RS may include a payload that carries the PCI. For example, referring to FIG. 6, at 606, the broadcast LP-RS may carry a PCI in a payload.

In one configuration, the LP-RS may comprise an OOK modulation scheme or an OFDMA modulation scheme. For example, referring to FIG. 4, the LP-RS 404 may comprise an OOK modulation scheme or an OFDMA modulation scheme. In another example, referring to FIG. 5, the LP-RS 504 may comprise an OOK modulation scheme or an OFDMA modulation scheme.

In one configuration, the LP-RS may be transmitted for L3-RSRP measurements associated with the cell. For example, referring to FIG. 6, at 606, the base station 604 may broadcast the LP-RS for L3-RSRP measurements associated with a cell associated with the base station 604.

In one configuration, the network node may transmit RMSI associated with the SSB and indicating a location of the LP-RS in at least one of time or frequency. For example, referring to FIG. 6, at 620, the base station 604 may transmit SIBs that include RMSI associated with an SSB, where the RMSI includes a location of the LP-RS in at least one of time or frequency.

In one configuration, the network node may indicate a cell selection parameter based on the LP-RS that is different than an SSB cell selection parameter. For example, referring to FIG. 6, at 634 the base station 604 may indicate a cell selection parameter.

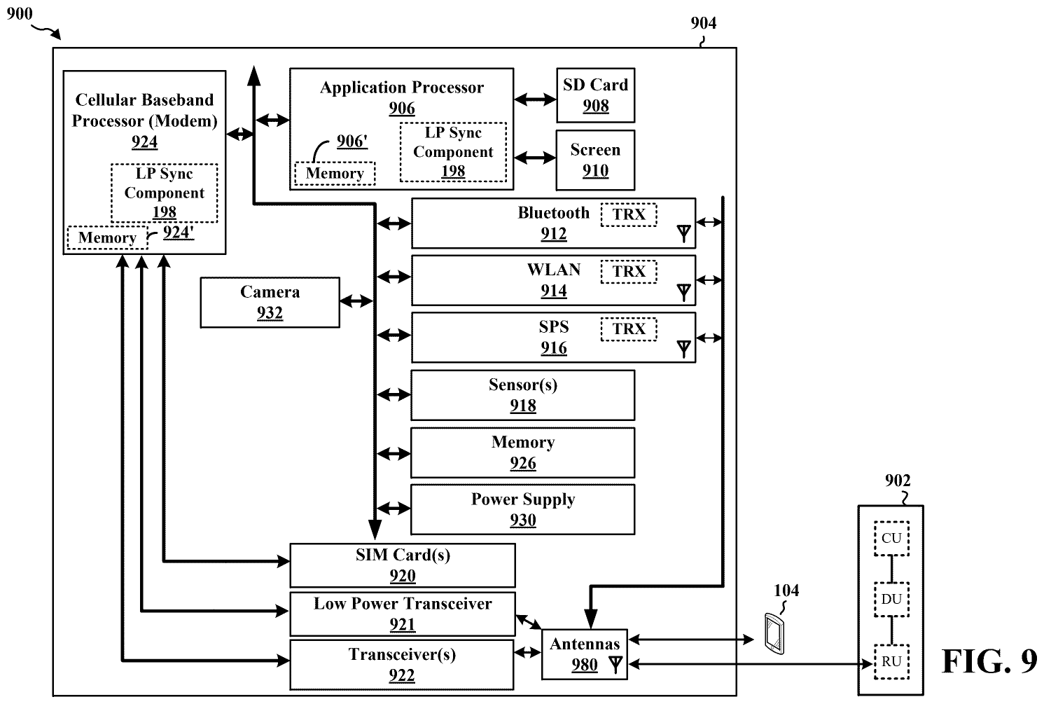

FIG. 9 is a diagram 900 illustrating an example of a hardware implementation for an apparatus 904. The apparatus 904 may be a UE, a component of a UE, or may implement UE functionality. In some aspects, the apparatus 904 may include a cellular baseband processor 924 (also referred to as a modem) coupled to one or more transceivers 922 (e.g., cellular RF transceiver). The cellular baseband processor 924 may include on-chip memory 924′. In some aspects, the apparatus 904 may further include one or more subscriber identity modules (SIM) cards 920 and an application processor 906 coupled to a secure digital (SD) card 908 and a screen 910. The application processor 906 may include on-chip memory 906′. In some aspects, the apparatus 904 may further include a Bluetooth module 912, a WLAN module 914, an SPS module 916 (e.g., GNSS module), one or more sensor modules 918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 926, a power supply 930, and/or a camera 932. The Bluetooth module 912, the WLAN module 914, and the SPS module 916 may include an on-chip transceiver (TRX) (or in some cases, just a receiver (RX)). The Bluetooth module 912, the WLAN module 914, and the SPS module 916 may include their own dedicated antennas and/or utilize the antennas 980 for communication. The cellular baseband processor 924 communicates through the transceiver(s) 921 and 922 via one or more antennas 980 with the UE 104 and/or with an RU associated with a network entity 902. For example, as described in connection with FIG. 6, the apparatus may include a low power transceiver 921 that uses less power than the transceiver(s) 922. The cellular baseband processor 924 and the application processor 906 may each include a computer-readable medium/memory 924′, 906′, respectively. The additional memory modules 926 may also be considered a computer-readable medium/memory. Each computer-readable medium/memory 924′, 906′, 926 may be non-transitory. The cellular baseband processor 924 and the application processor 906 are each responsible for general processing, including the execution of software stored on the computer-readable medium/memory. The software, when executed by the cellular baseband processor 924/application processor 906, causes the cellular baseband processor 924/application processor 906 to perform the various functions described supra. The computer-readable medium/memory may also be used for storing data that is manipulated by the cellular baseband processor 924/application processor 906 when executing software. The cellular baseband processor 924/application processor 906 may be a component of the UE 350 and may include the memory 360 and/or at least one of the TX processor 368, the RX processor 356, and the controller/processor 359. In one configuration, the apparatus 904 may be a processor chip (modem and/or application) and include just the cellular baseband processor 924 and/or the application processor 906, and in another configuration, the apparatus 904 may be the entire UE (e.g., see 350 of FIG. 3) and include the additional modules of the apparatus 904.

As discussed supra, the LP sync component 198 is configured to perform one or more RRM measurements on a LP-RS of at least one cell and select a cell on which to camp based on the one or more RRM measurements performed on the LP-RS. The LP sync component 198 may be further configured to perform any of the aspects described in connection with FIG. 7 and/or performed by the UE in FIG. 6. The LP sync component 198 may be within the cellular baseband processor 924, the application processor 906, or both the cellular baseband processor 924 and the application processor 906. The LP sync component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 904 may include a variety of components configured for various functions. In one configuration, the apparatus 904, and in particular the cellular baseband processor 924 and/or the application processor 906, includes means for performing one or more RRM measurements on a LP-RS of at least one cell and means for selecting a cell on which to camp based on the one or more RRM measurements performed on the LP-RS. The apparatus 904 may further include means to perform any of the aspects described in connection with FIG. 7 and/or performed by the UE in FIG. 6. The means may be the LP sync component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

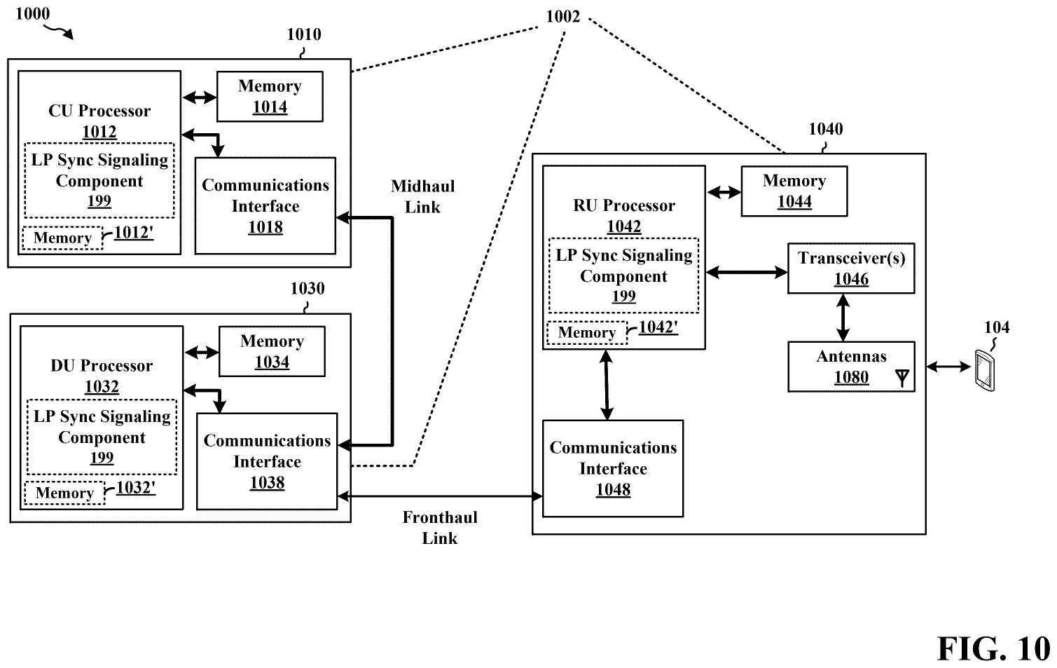

FIG. 10 is a diagram 1000 illustrating an example of a hardware implementation for a network entity 1002. The network entity 1002 may be a BS, a component of a BS, or may implement BS functionality. The network entity 1002 may include at least one of a CU 1010, a DU 1030, or an RU 1040. For example, depending on the layer functionality handled by the LP sync signaling component 199, the network entity 1002 may include the CU 1010; both the CU 1010 and the DU 1030; each of the CU 1010, the DU 1030, and the RU 1040; the DU 1030; both the DU 1030 and the RU 1040; or the RU 1040. The CU 1010 may include a CU processor 1012. The CU processor 1012 may include on-chip memory 1012′. In some aspects, the CU 1010 may further include additional memory modules 1014 and a communications interface 1018. The CU 1010 communicates with the DU 1030 through a midhaul link, such as an F1 interface. The DU 1030 may include a DU processor 1032. The DU processor 1032 may include on-chip memory 1032′. In some aspects, the DU 1030 may further include additional memory modules 1034 and a communications interface 1038. The DU 1030 communicates with the RU 1040 through a fronthaul link. The RU 1040 may include an RU processor 1042. The RU processor 1042 may include on-chip memory 1042′. In some aspects, the RU 1040 may further include additional memory modules 1044, one or more transceivers 1046, antennas 1080, and a communications interface 1048. The RU 1040 communicates with the UE 104. The on-chip memory 1012′, 1032′, 1042′ and the additional memory modules 1014, 1034, 1044 may each be considered a computer-readable medium/memory. Each computer-readable medium/memory may be non-transitory. Each of the processors 1012, 1032, 1042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the LP sync signaling component 199 is configured to transmit a SSB for a cell and transmit a LP-RS associated with the cell, the LP-RS configured for reception with a lower power than the SSB. The LP sync signaling component 199 may be further configured to perform any of the aspects described in connection with FIG. 8 and/or performed by the base station in FIG. 6. The LP sync signaling component 199 may be within one or more processors of one or more of the CU 1010, DU 1030, and the RU 1040. The LP sync signaling component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1002 may include a variety of components configured for various functions. In one configuration, the network entity 1002 includes means for transmitting a SSB for a cell and means for transmitting a LP-RS associated with the cell, the LP-RS configured for reception with a lower power than the SSB. The network entity may further include means to perform any of the aspects described in connection with FIG. 8 and/or performed by the base station in FIG. 6. The means may be the LP sync signaling component 199 of the network entity 1002 configured to perform the functions recited by the means. As described supra, the network entity 1002 may include the TX processor 316, the RX processor 370, and the controller/processor 375. As such, in one configuration, the means may be the TX processor 316, the RX processor 370, and/or the controller/processor 375 configured to perform the functions recited by the means.

A UE may be configured with a wakeup signal (WUS). In some configurations, a UE may be equipped with a low-power wakeup radio (LP-WUR) that utilizes less power than a main radio of the UE. There is a need to utilize a LP-WUR in different contexts (e.g., for synchronization) in order to reduce UE power consumption. To address issues pertaining to UE power consumption, enhancements to UE synchronization procedures using a LP-RS are described herein. A base station may transmit a LP-RS to a LP-WUR of a UE, where a location of the LP-RS is predefined based on a synchronization raster or based on remaining minimum system information (RMSI). The UE may perform a measurement (e.g., a L3-RSRP measurement) on the LP-RS. The UE may also perform measurements on LP-RSs received by the LP-WUR from neighbor cells. The UE may derive equivalent RSRP measurements on an SSB using RSRP measurements on the LP-RS. The UE may utilize the equivalent RSRP measurements on the SSB in cell selection/reselection. As the LP-WUR receives the LP-RSs (as opposed to a main radio of the UE which receives SSBs), the UE is able to perform cell selection/reselection using less power than cell selection/reselection performed using SSBs. According to some configurations, the UE utilizes for LP-RS for additional purposes such as cell barring, intra-frequency reselection, and/or system information change.

In an example, a UE performs one or more RRM measurements on a LP-RS of at least one cell and selects a cell on which to camp based on the one or more RRM measurements performed on the LP-RS. Thus, the UE may utilize the LP-RS for cell selection/reselection purposes without having to continually measure SSBs. As measuring the LP-RS may consume less UE power than measuring an SSB, UE power consumption is reduced.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), comprising: performing one or more radio resource management (RRM) measurements on a low-power reference signal (LP-RS) of at least one cell; and select a cell on which to camp based on the one or more RRM measurements performed on the LP-RS.
Aspect 2 is the method of aspect 1, where the LP-RS is configured for reception with a reduced power relative to reception of a synchronization signal block (SSB) for the at least one cell.
Aspect 3 is the method of any of aspects 1-2, wherein the one or more RRM measurements are performed on the LP-RS using a second receiver that operates using less power than a first receiver.
Aspect 4 is the method of any of aspects 1-3, further comprising: prior to receiving the LP-RS associated with a serving cell: receiving a synchronization signal block (SSB) associated with the serving cell; and acquiring information about the LP-RS based on the SSB or from remaining system information (RMSI) associated with the SSB.
Aspect 5 is the method of any of aspects 1-4, further comprising: prior to receiving the LP-RS associated with a serving cell: determining a time and frequency location of a synchronization signal block (SSB) associated with the serving cell based on a sync raster; and determining a location of the LP-RS based on the time and frequency location of the SSB associated with the serving cell.
Aspect 6 is the method of aspect 5, where the LP-RS is transmitted at a first periodicity and the SSB is transmitted at a second periodicity.
Aspect 7 is the method of any of aspects 1-6, where the UE is in a radio resource control (RRC) idle or inactive state.
Aspect 8 is the method of any of aspects 1-7, where the LP-RS is identified by a physical cell identity (PCI) for a serving cell.
Aspect 9 is the method of aspect 8, where the LP-RS includes a payload that carries the PCI.
Aspect 10 is the method of any of aspects 1-9, wherein the LP-RS includes a payload that includes at least one of: a cell barring indication, an intra-frequency reselection indication, or a system information change notification.
Aspect 11 is the method of any of aspects 1-10, where the LP-RS comprises an on off keying (OOK) modulation scheme or an orthogonal frequency-division multiple access (OFDMA) modulation scheme.
Aspect 12 is the method of any of aspects 1-11, where the one or more RRM measurements comprise layer 3 reference signal received power (L3-RSRP) measurements.
Aspect 13 is the method of any of aspects 1-12, further comprising: performing, prior to receive the LP-RS associated with a serving cell, a first measurement on a synchronization signal block (SSB) associated with the serving cell.
Aspect 14 is the method of any of aspects 1-13, further comprising: performing cell reselection based on the one or more RRM measurements performed on the LP-RS for the cell and second one or more RRM measurements performed on a second LP-RS for at least one neighbor cell.
Aspect 15 is the method of any of aspects 1-14, further comprising: deriving time and frequency locations of LP-RSs associated with at least one neighbor cell indicated in system information, where performing the one or more RRM measurements includes: performing second one or more RRM measurements on the LP-RSs of the at least one neighbor cell.
Aspect 16 is the method of any of aspects 1-15, deriving an estimated reference signal received power (RSRP) of a corresponding synchronization signal block (SSB) based upon the one or more RRM measurements on the LP-RS and an offset; and selecting the cell based on the estimated RSRP of the corresponding SSB and a threshold.
Aspect 17 is the method of aspect 16, further comprising: estimating the offset based upon a difference between the one or more RRM measurements performed on the LP-RS and corresponding RRM measurements performed on the corresponding SSB.
Aspect 18 is the method of aspect 16, further comprising: receiving the offset from a network entity.
Aspect 19 is the method of any of aspects 1-18, further comprising: receiving an LP-RS cell selection parameter from a network entity, the LP-RS cell selection parameter being different than an SSB cell selection parameter, where selecting the cell is further based upon the LP-RS cell selection parameter.
Aspect 20 is the method of any of aspects 1-19, further comprising: selecting, prior to performing the one or more measurements on the LP-RS of the at least one cell, the LP-RS based on at least one condition.
Aspect 21 is the method of aspect 20, wherein the LP-RS is selected from a group comprising the LP-RS and a synchronization signal block (SSB).
Aspect 22 is an apparatus for wireless communication at a user equipment (UE) comprising a memory and at least one processor coupled to the memory and configured to perform a method in accordance with any of aspects 1-21.
Aspect 23 is an apparatus for wireless communication, including means for performing a method in accordance with any of aspects 1-21.
Aspect 24 is the apparatus of aspect 22 or 23, further including a first receiver and a second receiver, wherein the second receiver operates using less power than the first receiver, and wherein the second receiver is configured to perform the one or more RRM measurements on the LP-RS.
Aspect 25 is a non-transitory computer-readable medium including instructions that, when executed by an apparatus, cause the apparatus to perform a method in accordance with any of aspects 1-21.
Aspect 26 is a method for wireless communication at a network node, comprising: transmitting a synchronization signal block (SSB) for a cell; and transmitting a low-power reference signal (LP-RS) associated with the cell, the LP-RS configured for reception with a lower power than the SSB.
Aspect 27 is the method of aspect 26, wherein the LP-RS is broadcast at a first periodicity and the SSB is broadcast at a second periodicity.
Aspect 28 is the method of any of aspects 26-27, wherein the LP-RS is identified by a physical cell identity (PCI) for the cell.
Aspect 29 is the method of any of aspects 26-28, wherein the LP-RS comprises an on off keying (OOK) modulation scheme or an orthogonal frequency-division multiple access (OFDMA) modulation scheme.
Aspect 30 is the method of any of aspects 26-29, wherein the LP-RS is transmitted for layer 3 reference signal received power (L3-RSRP) measurements associated with the cell.
Aspect 31 is the method of any of aspects 26-30, further comprising: transmitting remaining minimum system information (RMSI) associated with the SSB and indicating a location of the LP-RS in at least one of time or frequency.
Aspect 32 is the method of any of aspects 26-31, further comprising: indicating a cell selection parameter based on the LP-RS that is different than an SSB cell selection parameter.
Aspect 33 is an apparatus for wireless communication at a network node comprising a memory and at least one processor coupled to the memory and configured to perform a method in accordance with any of aspects 26-32.
Aspect 34 is an apparatus for wireless communication, including means for performing a method in accordance with any of aspects 26-32.
Aspect 35 is a non-transitory computer-readable medium including instructions that, when executed by an apparatus, cause the apparatus to perform a method in accordance with any of aspects 26-32.
Aspect 36 is the apparatus of aspect 33 or 34, further including at least one transceiver configured to transmit the SSB and transmit the LP-RS.

What is claimed is:

1. An apparatus for wireless communication at a user equipment (UE), comprising:
a memory; and
at least one processor coupled to the memory and, based at least in part on stored information stored in the memory, the at least one processor is configured to:
perform one or more radio resource management (RRM) measurements on a low-power reference signal (LP-RS) of at least one cell; and
select a cell on which to camp based on the one or more RRM measurements performed on the LP-RS.

2. The apparatus of claim 1, wherein the LP-RS is configured for reception with a reduced power relative to reception of a synchronization signal block (SSB) for the at least one cell.

3. The apparatus of claim 1, further comprising:
a first receiver; and
a second receiver, wherein the second receiver operates using less power than the first receiver, and wherein the one or more RRM measurements are performed on the LP-RS using the second receiver.

4. The apparatus of claim 1, wherein the at least one processor is further configured to:
prior to receive the LP-RS associated with a serving cell:
receive a synchronization signal block (SSB) associated with the serving cell; and
acquire information about the LP-RS based on the SSB or from remaining system information (RMSI) associated with the SSB.

5. The apparatus of claim 1, wherein the at least one processor is further configured to:
prior to receive the LP-RS associated with a serving cell:
determine a time and frequency location of a synchronization signal block (SSB) associated with the serving cell based on a sync raster; and
determine a location of the LP-RS based on the time and frequency location of the SSB associated with the serving cell.

6. The apparatus of claim 5, wherein the LP-RS is transmitted at a first periodicity and the SSB is transmitted at a second periodicity.

7. The apparatus of claim 1, wherein the UE is in a radio resource control (RRC) idle or inactive state.

8. The apparatus of claim 1, wherein the LP-RS is identified by a physical cell identity (PCI) for a serving cell.

9. The apparatus of claim 8, wherein the LP-RS includes a payload that carries the PCI.

10. The apparatus of claim 1, wherein the LP-RS includes a payload that includes at least one of:
a cell barring indication,
an intra-frequency reselection indication, or
a system information change notification.

11. The apparatus of claim 1, wherein the LP-RS comprises an on off keying (OOK) modulation scheme or an orthogonal frequency-division multiple access (OFDMA) modulation scheme.

12. The apparatus of claim 1, wherein the one or more RRM measurements comprise layer 3 reference signal received power (L3-RSRP) measurements.

13. The apparatus of claim 1, wherein the at least one processor is further configured to:
perform, prior to receive the LP-RS associated with a serving cell, a first measurement on a synchronization signal block (SSB) associated with the serving cell.

14. The apparatus of claim 1, wherein the at least one processor is further configured to:
perform cell reselection based on the one or more RRM measurements performed on the LP-RS for the cell and second one or more RRM measurements performed on a second LP-RS for at least one neighbor cell.

15. The apparatus of claim 1, wherein the at least one processor is further configured to:
derive time and frequency locations of LP-RSs associated with at least one neighbor cell indicated in system information, wherein perform the one or more RRM measurements includes:
perform second one or more RRM measurements on the LP-RSs of the at least one neighbor cell.

16. The apparatus of claim 1, wherein the at least one processor is further configured to:
derive an estimated reference signal received power (RSRP) of a corresponding synchronization signal block (SSB) based upon the one or more RRM measurements on the LP-RS and an offset; and
select the cell based on the estimated RSRP of the corresponding SSB and a threshold.

17. The apparatus of claim 16, wherein the at least one processor is further configured to:
estimate the offset based upon a difference between the one or more RRM measurements performed on the LP-RS and corresponding RRM measurements performed on the corresponding SSB.

18. The apparatus of claim 16, wherein the at least one processor is further configured to:
receive the offset from a network entity.

19. The apparatus of claim 1, wherein the at least one processor is further configured to:
receive an LP-RS cell selection parameter from a network entity, the LP-RS cell selection parameter being different than an SSB cell selection parameter, wherein selecting the cell is further based upon the LP-RS cell selection parameter.

20. The apparatus of claim 1, wherein the at least one processor is further configured to:
select, prior to perform the one or more measurements on the LP-RS of the at least one cell, the LP-RS based on at least one condition.

21. The apparatus of claim 20, wherein the LP-RS is selected from a group comprising the LP-RS and a synchronization signal block (SSB).

22. A method of wireless communication at a user equipment (UE), comprising:
performing one or more radio resource management (RRM) measurements on a low-power reference signal (LP-RS) of at least one cell; and
selecting a cell on which to camp based on the one or more RRM measurements performed on the LP-RS.

23. An apparatus for wireless communication at a network node, comprising:
a memory; and
at least one processor coupled to the memory and, based at least in part on information stored in the memory, the at least one processor is configured to:
transmit a synchronization signal block (SSB) for a cell; and
transmit a low-power reference signal (LP-RS) associated with the cell, the LP-RS configured for reception with a lower power than the SSB.

24. The apparatus of claim 23, wherein the LP-RS is broadcast at a first periodicity and the SSB is broadcast at a second periodicity.

25. The apparatus of claim 23, wherein the LP-RS is identified by a physical cell identity (PCI) for the cell.

26. The apparatus of claim 23, wherein the LP-RS comprises an on off keying (OOK) modulation scheme or an orthogonal frequency-division multiple access (OFDMA) modulation scheme.

27. The apparatus of claim 23, wherein the LP-RS is transmitted for layer 3 reference signal received power (L3-RSRP) measurements associated with the cell.

28. The apparatus of claim 23, wherein the at least one processor is further configured to:
transmit remaining minimum system information (RMSI) associated with the SSB and indicating a location of the LP-RS in at least one of time or frequency.

29. The apparatus of claim 23, wherein the at least one processor is further configured to:
indicate a cell selection parameter based on the LP-RS that is different than an SSB cell selection parameter.

30. A method of wireless communication at a network node, comprising:
transmitting a synchronization signal block (SSB) for a cell; and
transmitting a low-power reference signal (LP-RS) associated with the cell, the LP-RS configured for reception with a lower power than the SSB.
